(19) United States
(12) Patent Application Publication
(10) Pub. No.: US 2009/0138453 A1
(43) Pub. Date: May 28, 2009

(54) SYSTEM AND METHOD FOR SEARCHING LARGE AMOUNT OF DATA AT HIGH SPEED FOR DIGITAL FORENSIC SYSTEM

(76) Inventors: Hyungkeun Jee, Dajeon-city (KR); Dowon Hong, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/119,002

(22) Filed: May 12, 2008

(30) Foreign Application Priority Data
Nov. 26, 2007 (KR) 10-2007-0120759

(51) Int. Cl. G06F 17/30

(52) U.S. Cl. 707/4; 707/E17.108

(57) ABSTRACT

Disclosed is a system and method for searching a large amount of data for a digital forensic system. A method of searching a large amount of data at high speed for a digital forensic method includes: allowing an image storage module to receive a disk image to be searched; allowing an analyzing module to analyze the disk image input from the image storage module to generate an index of files existing in the disk image; allowing a high-speed searching module to rearrange clusters by files, the clusters corresponding to the disk image input from the image storage module; allowing the high-speed searching module to extract text data from files having the text data, and store the text data; and allowing the high-speed searching module to search for at least one keyword by using a bitwise searching manner.

### BACKGROUND OF THE INVENTION

1. Field of the Invention

The present invention relates to a system and method for searching a large amount of data at a high speed, and more particularly, to a system and method for searching a large amount of data at a high speed in a digital forensic system for analyzing digital evidence.

This invention was supported by the IT R&D program of MIC/IITA [2007-S-019-01, Development of Digital Forensic System for Information Transparency].

2. Description of the Related Art

Computer forensic describes a sequence of processes of collecting and analyzing data and making a report on the basis of the analyzed data in a computer system. Computer forensic is a field that is coming into the spotlight due to various evidence data being found on computer systems or various storage devices regarding criminal investigation.

Computer forensic is a sequence of searching processes repeatedly performed to search for desired data. However, as the capacity of storage devices rapidly increases, it may take several days or more to search for related evidence, which may delay an investigation. In general, examples of searching methods for computer forensic include an index-based searching method and a bitwise searching method.

An index-based searching method is a file-based searching method, which generates, in advance, an index on the basis of different types of words included in all of the files on a disk and performs a search. An advantage of the index-based searching method is that a search can be performed in real time after the initial indexing and can be performed on various file formats such as DOC and PDF. However, it takes the index-based searching method a large amount of time to perform an initial indexing process. Further, since a search is performed in logical file units, it is impossible to search data in a slack space and an unallocated space. Therefore, it is difficult to apply the index-based searching method to a digital forensic system.

FIG. 1 is a flowchart illustrating an index-based information searching method according to the related art.

An index-based information searching method generates an index for searching a large amount of documents stored in, for example, a disk, at high speed (S10), loads the index into a database (S11), generates an index file (S12), inputs a search character string into a search engine (S13), searches for documents including a character string having the same or similar character arrangement as or to the search character string at high speed by using the index file in the search engine (S14), and displays the search results (S15).

Index files of a searching system include a character chain file, a location information file, an expansion character chain file, and an expansion location information file. In the character chain file, a variable length chain, a fixed length chain, a paragraph pattern, a document number corresponding to the paragraph pattern, and data on where a location number in a document is positioned in the location information file are stored. In the location information file, a document number and a location number in a document are stored. In the expansion character chain file, an expansion character chain, a variable length chain number corresponding to the expansion character chain, and data on where a location number in a variable length chain is positioned in the expansion location information file are stored. In the expansion location information file, a variable length chain number and a location number in a variable length chain are stored. These index files are used to search for documents including a character string having the same or similar character arrangement as or to a designated character string at high speed.

The bitwise searching method searches all bits from the beginning to the end of a disk. An advantage of this method is that it is possible to search data existing in a slack space and an unallocated space, perform a search using a complicated regular expression as well as a keyword, and search binary data such as file headers, which are not text.

However, the bitwise searching method cannot search files such as MS office files, and PDF files, which are not stored in an ASCII format. Further, since a search is performed on all of the bits on a disk, it takes a large amount of time to perform a search. Furthermore, when a file is stored in many clusters and the clusters do not neighbor one another, or when a search keyword extends over two clusters, the bitwise searching method may not perform the search.

### SUMMARY OF THE INVENTION

Accordingly, it is an object of the present invention to provide a system and method for searching a large amount of data at high speed in a digital forensic system for analyzing digital evidence, which rearranges clusters in a high-capacity disk image by files, converts files having text data in the disk image (files having formats) into text files, and rapidly and exactly searches for a specific keyword or a regular expression from a high-capacity storage medium by bitwise searching using a pattern matching board.

According to an aspect of the present invention, there is provided a system for searching a large amount of data at high speed for a digital forensic system. The system includes: an image storage module that stores a disk image of a disk to be searched; an analyzing module that analyzes the disk image input from the image storage module to analyze clusters where files in the disk are stored; and a high-speed searching module that receives the disk image from the image storage module, searches for at least one keyword, and provides the searching results. In this system, the high-speed searching module may rearrange the clusters corresponding to the received disk image by files, extract text data from files having the text data, convert the text data into text files, store the text files, and perform bitwise searching.

The high-speed searching module may search for multiple desired keywords at the same time by using a pattern matching board.

The high-speed searching module may search at least one keyword and a regular expression from all sectors of the disk image and the converted text files by using a pattern matching board.

After the high-speed searching module generates the converted text files, the image storage module may store the converted text files together with the disk image.

The high-speed searching module may rearrange clusters so that the clusters of each of the files are sequentially disposed to be next to each other.

According to another aspect of the present invention, there is provided a method of searching a large amount of data at high speed for a digital forensic system. The method includes: allowing an image storage module to receive a disk image to be searched; allowing an analyzing module to analyze the disk image input from the image storage module to generate an index of files existing in the disk image; allowing a high-speed searching module to rearrange clusters by files, the clusters corresponding to the disk image input from the image storage module; allowing the high-speed searching module to extract text data from files having the text data, and store the text data; and allowing the high-speed searching module to search for at least one keyword by using a bitwise searching manner.

The analysis of the disk image by the analyzing module may include: analyzing the input disk image to find a used file system; and generating an index of files existing in the disk image.

The rearrangement of the clusters by the high-speed searching module may include rearranging clusters so that the clusters of each of the files are sequentially disposed to be next to each other.

The extraction of the text data by the high-speed searching module may include: extracting the text data from the files having the text data by using parsers corresponding to the formats of the individual files; and storing the extracted text data together with the disk image in the image storage module.

The search of the keyword by the high-speed searching module may include searching multiple desired keywords at the same time using a pattern matching board of a bitwise searching method.

### BRIEF DESCRIPTION OF THE DRAWINGS

FIG. 1 is a flowchart illustrating an index-based information searching method according to the related art;

FIG. 2 is a diagram illustrating the overall configuration of a digital forensic system including a high-speed searching module according to an embodiment of the present invention;

FIG. 3 is a flowchart illustrating a method of searching a large amount of data at high speed for a digital forensic system according to an embodiment of the present invention;

FIG. 4 is a diagram illustrating cluster rearrangement in a high-speed searching process; and

FIG. 5 is a diagram illustrating a file slack space in the high-speed searching process.

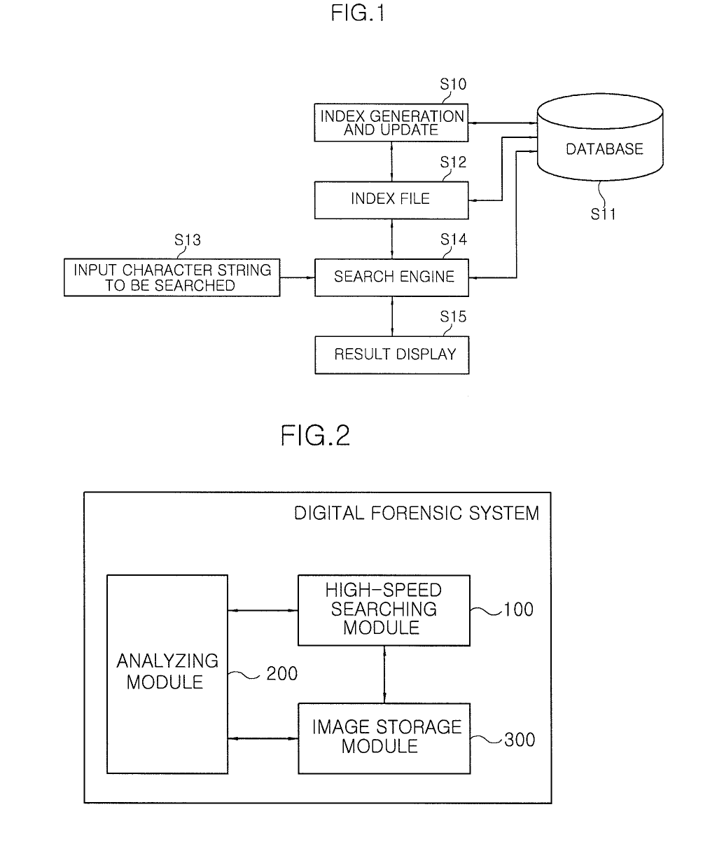

### DESCRIPTION OF THE PREFERRED EMBODIMENTS

Hereinafter, preferred embodiments of the present invention will be described in detail with reference to the accompanying drawings.

FIG. 2 is a diagram illustrating the overall configuration of a digital forensic system including a high-speed searching module according to an embodiment of the present invention.

A digital forensic system according to an embodiment of the present invention includes a high-speed searching module 100, an analyzing module 200, and an image storage module 300.

The image storage module 300 provides a disk image to be searched. After the high-speed searching module 100 generates the converted text files, the image storage module 300 stores the converted text file together with the disk image.

The analyzing module 200 analyzes which file system the input disk image uses and analyzes which clusters of the file system files in a disk are stored in.

When receiving a search request from the analyzing module 200, the high-speed searching module 100 receives the disk image from the image storage module 300, generates a file system from the received disk image, and rearranges clusters by files. Further, the high-speed searching module 100 converts files including text data (hereinafter, referred to as ‘files having formats’) into text files, stores the text files, searches for a desired keyword or a regular expression from all sectors of the image and the text files by using a pattern matching board, and transmits the search results to the analyzing module 200.

The files including text data (files having formats) means files such as MS office files, and PDF files, which are not stored in an ASCII format in the disk image.

The pattern matching board is generally used in an IDS (Intrusion Detection System) for a network. When a packet is uploaded to a network, the pattern matching board searches for a specific keyword or a regular expression to detect intrusion. In this embodiment of the present invention, the pattern matching board is used to search for a keyword or a regular expression in a computer.

The high-speed searching module 100 searches for multiple desired keywords at the same time using the pattern matching board of a bitwise searching method.

The analyzing module 200 asks the high-speed searching module 100 to perform searching, receives the search results from the high-speed searching module 100, and analyzes searched keywords.

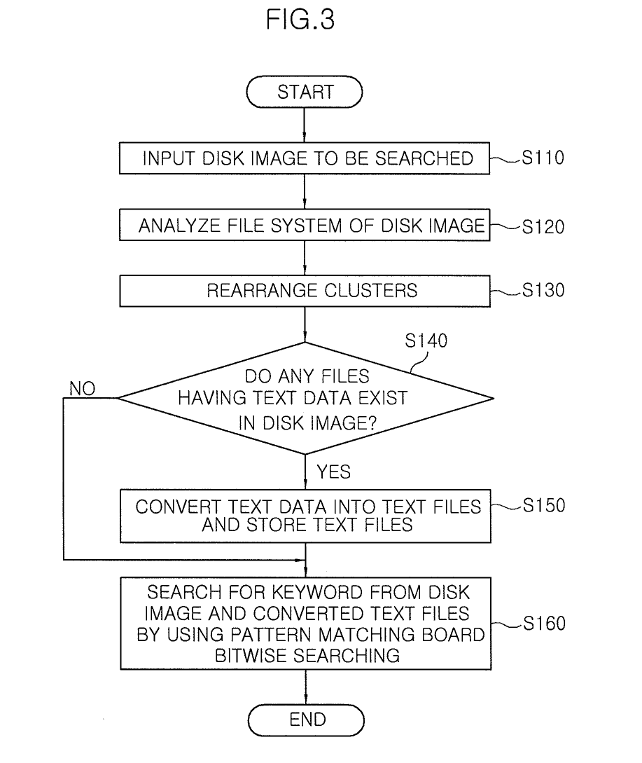

FIG. 3 is a flowchart illustrating a method of searching a large amount of data at high speed for a digital forensic system according to an embodiment of the present invention.

When a disk image to be searched is input from the image storage module 300 (S110), the analyzing module 200 analyzes a file system of the disk image (S120).

The file system is determined in advance for data input/output with respect to a storage device. Therefore, the analyzing module 200 finds which file system the input disk image uses and analyzes the file system to find which files are stored in the disk, which clusters the files are stored in, and which format the files are stored in.

When one file is stored in many clusters, a situation in which the file is not sequentially stored in continuous clusters frequently occurs. Further, when a desired keyword extends over two clusters which do not neighbor each other, the search fails. Therefore, the digital forensic system needs a process of rearranging clusters before searching so that the clusters are sequentially positioned by files.

The analyzing module 200 analyzes the file system to find which files are stored in the disk image and which clusters the files are stored in and then the high-speed searching module 100 rearranges the clusters so that the clusters are sequentially positioned by files (S130).

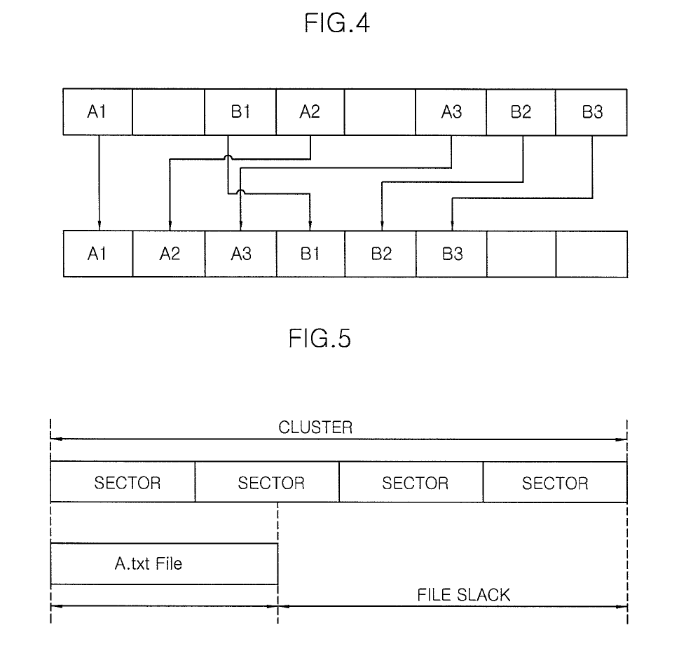

After rearranging the clusters by files as shown in FIG. 4, the high-speed searching module 100 searches for files having text data (files having formats) in the disk image, converts the searched files into text files, and stores the converted text files in the image storage module 300.

This is because it is basically impossible to search files such as MS office files, and PDF files, which are not stored in an ASCII format, in the disk image.

The high-speed searching module 100 determines whether any of the files having text data (files having formats) exist in the disk image (S140).

If any of the files having formats exist in the disk image, the high-speed searching module 100 extracts only text data from the original data of each of the files having formats by using a parser corresponding to each format, converts the text data into text files, and stores the converted text files together with the disk image in the image storage module 300 (S150).

Next, the high-speed searching module 100 performs bitwise searching on the disk image and the converted text files by using the pattern matching board (S160).

The bitwise searching takes a large amount of time. The bitwise searching is frequently used to search for multiple keywords at the same time. In this case, the bitwise searching requires even more time. However, when bitwise searching is performed by using a pattern matching board, it is possible to search for multiple keywords within a predetermined time period. Therefore, the high-speed searching module 100 of the digital forensic system according to the embodiment of the present invention uses the pattern matching board to search the disk image and to sequentially search the text files converted in order to search files having formats (for example, MS office and PDF documents) that are impossible to search.

The high-speed searching method for a digital forensic system according to the embodiment of the present invention can search data existing in a slack space or an unallocated space, perform a search using a complicated regular expression as well as a keyword, and search binary data such as file headers, which are not text.

FIG. 5 is a diagram illustrating a file slack space in a high-speed searching process.

A cluster is a logical basic unit of a storage device, in which an operating system reads or writes data. The file system stores the files in cluster units. If the size of the cluster is 4096 bytes, the file system assigns 4096 bytes even in a case of storing a file having a size of 1000 bytes and the remaining space of 3096 bytes is not used. The remaining space is referred to as slack space. The slack space has an important meaning in computer forensic. This is because when deleting files, most file systems do not delete the contents of the files but delete only pointers regarding the files.

If a file having a size of 4000 bytes is deleted and a file having a size of 1000 bytes is overwritten in that space, 3000 bytes of data of the deleted file remains intact. However, it is impossible to search the contents of 3000 bytes of data in a file-based searching manner. However, if searching the disk from the beginning to the end by using a bitwise searching method, the high-speed searching module 100 can search the contents of the deleted data.

The high-speed searching method according to the embodiment of the present invention can search all character strings and patterns in the disk from the disk image by bitwise searching at high speed, search data existing in a slack space, perform searching using a regular expression, and search binary data such as file headers which are not text.

As described above, according to the embodiments of the present invention, in a digital forensic system, a file system is generated from a high-capacity disk image, clusters are rearranged by files, files having formats are converted into text files, and bitwise searching is performed by using a pattern matching board. Therefore, it is possible to rapidly and exactly search for a desired keyword or regular expression and to improve the reliability and speed of searching in the digital forensic system.

In the drawings and specification, there have been disclosed typical embodiments of the present invention and, although specific terms are employed, they are used in a generic and descriptive sense only and not for purposes of limitation. It will be apparent to those skilled in the art that modifications and variations can be made in the present invention without deviating from the spirit or scope of the invention. Thus, it is intended that the present invention cover any such modifications and variations of this invention provided they come within the scope of the appended claims and their equivalents.

What is claimed is:

1. A system for searching a large amount of data at high speed for a digital forensic system, the system comprising:
an image storage module that stores a disk image of a disk to be searched;
an analyzing module that analyzes the disk image input from the image storage module to analyze clusters where files in the disk are stored; and
a high-speed searching module that receives the disk image from the image storage module, searches for at least one keyword, and provides the searching results,
wherein the high-speed searching module rearranges the clusters that correspond to the received disk image by files, extracts text data from files having the text data, converts the text data into text files, and performs bitwise searching.

2. The system of claim 1,
wherein the high-speed searching module searches for multiple desired keywords at the same time by using a pattern matching board.

3. The system of claim 1,
wherein the high-speed searching module searches at least one keyword and a regular expression from all sectors of the disk image and the converted text files by using a pattern matching board.

4. The system of claim 1,
wherein, after the high-speed searching module generates the converted text files, the image storage module stores the converted text files together with the disk image.

5. The system of claim 1,
wherein the high-speed searching module rearranges clusters so that clusters of each of the files are sequentially disposed to be next to each other.

6. A method of searching a large amount of data at high speed for a digital forensic method, the method comprising:
allowing an image storage module to receive a disk image to be searched;
allowing an analyzing module to analyze the disk image input from the image storage module to generate an index of files existing in the disk image;
allowing a high-speed searching module to rearrange clusters by files, the clusters corresponding to the disk image input from the image storage module;
allowing the high-speed searching module to extract text data from files having the text data, and store the text data; and
allowing the high-speed searching module to search for at least one keyword by using a bitwise searching method.

7. The method of claim 6,
wherein the analysis of the disk image by the analyzing module includes:
analyzing the input disk image to find a used file system; and
generating an index of files existing in the disk image.

8. The method of claim 6,
wherein the rearrangement of the clusters by the high-speed searching module includes rearranging clusters so that the clusters of each of the files are sequentially disposed to be next to each other.

9. The method of claim 6,
wherein the extraction of the text data by the high-speed searching module includes:
extracting the text data from the files having the text data by using parsers corresponding to the formats of the individual files; and
storing the extracted text data together with the disk image in the image storage module.

10. The method of claim 6,
wherein the search of the keyword by the high-speed searching module includes searching multiple desired keywords at the same time in the bitwise searching method using a pattern matching board.
